(19) United States
(12) Patent Application Publication
(10) Pub. No.: US 2010/0169213 A1
(43) Pub. Date: Jul. 1, 2010

(54) METHODS AND SYSTEMS FOR DEPOSITING VALUE-BEARING INSTRUMENTS IN A FINANCIAL ACCOUNT, AND PRODUCTS THEREBY

(76) Inventors: Chad Keith, St. Louis, MO (US); Jeff Clark, San Antonio, TX (US)

Correspondence Address: AT&T Legal Department - GT;Attn: Patent Docketing, Room 2A-207, One AT&T Way, Bedminster, NJ, 07921, US

(21) Appl. No.: 12/346,140

(22) Filed: Dec. 30, 2008

(51) Int. Cl. G06Q 40/00

(52) U.S. Cl. 705/44

(57) ABSTRACT

Methods, systems and products thereby for depositing a value-bearing instrument in a financial account remotely from a financial institution are disclosed. The system may include a processor configured to receive an electronic image of the value-bearing instrument, determine a user's financial account information, and transmit the electronic image or a replica thereof to a financial institution for processing. The products include computer readable mediums for providing instructions to cause the processor to perform the operations above. As such, the methods, systems and products embodied in the present disclosure allow a user to deposit value-bearing instruments without traveling to their financial institution, and allow financial institutions to reduce in-person transactions and associated personnel costs while receiving timely deposits into their asset management control.

### BACKGROUND

Presently, to deposit a value-bearing instrument, such as a personal check, a certified check, a money order, and the like, in a financial account, a person needs to visit his/her financial institution, such as a local bank branch. The value-bearing instrument may be presented to a bank teller or deposited in a bank machine. This is costly to bank branches and inconvenient to its customers.

The present disclosure relates generally to banking and more specifically to methods and systems for electronically depositing value-bearing instruments in the financial account remotely from the financial institution.

### DRAWINGS

The above-mentioned features and objects of the present disclosure will become more apparent with reference to the following description taken in conjunction with the accompanying drawings wherein like reference numerals denote like elements and in which:

FIG. 1 illustrates a block diagram of a system for depositing a value-bearing instrument in a financial account, according to an embodiment of the present disclosure.

FIG. 2 illustrates an exemplary flowchart outlining the operation of a system for depositing a value-bearing instrument in a financial account, according to an embodiment of the present disclosure.

FIG. 3 illustrates an exemplary flowchart outlining the operation of a user terminal executing instructions for depositing a value-bearing instrument in a financial account, according to an embodiment of the present disclosure.

### DETAILED DESCRIPTION

In the description that follows, the present invention will be described in reference to preferred embodiments that relates to methods and systems for electronically depositing value-bearing instruments in a financial account remotely from a financial institution. The present invention, however, is not limited to any particular application nor is it limited by the examples described herein. Therefore, the description of the embodiments that follow are for purposes of illustration and not limitation.

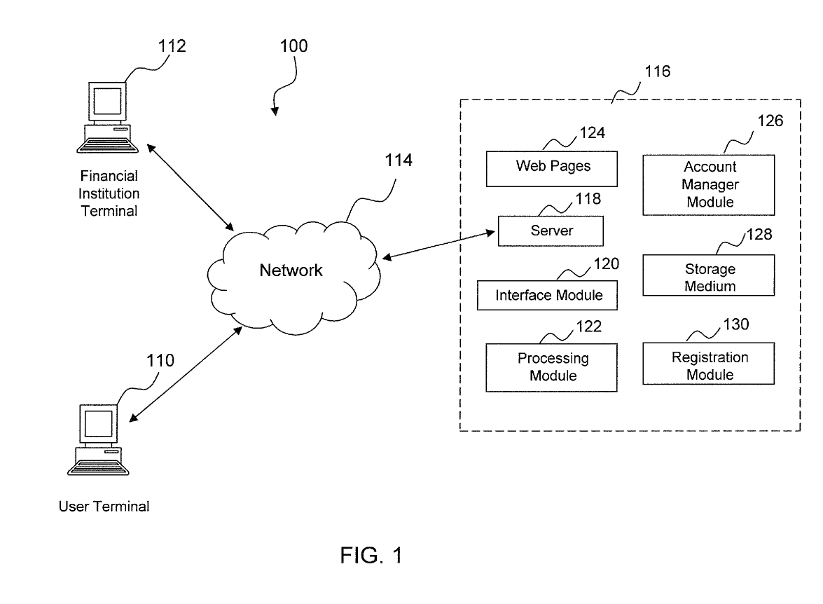

FIG. 1 illustrates a block diagram of a system 100 for depositing a value-bearing instrument in a financial account, according to an embodiment of the present disclosure. A user may deposit the value-bearing instrument in the financial account using an online banking deposit service. A service provider website 116 may be accessible to a user terminal 110 and a financial institution terminal 112, such as personal computers, phones, personal digital assistants, facsimiles, scanners, and the like, via a network 114. The terminals 110, 112 may run commercially-available Web browser applications such as Microsoft Internet Explorer®, which implements World Wide Web standards such as HTTP, HTML, XML, Java, Flex, Ajax and the like. The network 114 may include Internet, cable, cellular communications and the like.

In one embodiment, the service provider website 116 may include a server 118, one or more modules and one or more databases. A website operator may distribute the website content over several Internet domains, and may be implement the website 116 using several servers located at various locations. Of course, a variety of networks, both public and private, may be used by the website operator as well. The service provider website 116 may use a commercially-available Internet server 118 which accesses a web page database 124 that may be used to store and/or dynamically generate Web pages in response to end user actions. The Web pages may be in the form of HTML pages or the like.

The server 118 may access one or more databases, such as storage medium 128. As is well known, database categories can be combined, further divided or cross-correlated, and any combination of databases and the like can be provided from within the server 118. In one embodiment, any portion of the databases can be provided externally from the service provider website 116, either locally on the server 118, or remotely over a network. The external data from an external database can be provided in any standardized form which the server 118 can understand. For example, an external database at a provider can advantageously provide end-user data in response to requests from server 118 in a standard format, such as, for example, name, user identification, user's financial account information with a financial institution, and the like. The server 118 may transform the end-user data blocks to a function call format, which the code modules can then understand.

As can be appreciated, the storage medium 128 may store, arrange and retrieve data. The storage medium 128 may be one or more storage devices such as machine-readable mediums, which may be any mechanism that provides (i.e. stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. Additionally, machine-readable medium may also comprise computer storage media and communication media. Machine-readable medium includes volatile and non-volatile, removable and non-removable media implemented in any method or technology for storage of information such as computer-readable instructions, data structures, program modules or other data. Machine-readable medium also includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by a computer.

The website operator may implement the service provider website 116 as one or more functional modules including an interface module 120, a processing module 122, an account manager module 126, and a registration module 130. As used herein, the term module refers to logic embodied in hardware or firmware, or to a collection of software instructions, possibly having entry and exit points, written in a programming language, such as, for example, C++. The website operator may compile and link a software module into an executable program, or install it in a dynamic link library, or write it in an interpretive language such as BASIC. It will be appreciated that software modules may be callable from other modules, and/or may be invoked in response to detected events or interrupts. The website operator may embed software instructions in firmware, such as an EPROM. It will be further appreciated that hardware modules may comprise connected logic units, such as gates and flip-flops, and/or may comprise programmable units, such as programmable gate arrays. The modules described herein are preferably implemented as software modules, but could be represented in hardware or firmware.

In one embodiment, each module is provided as a modular code object, where the code objects typically interact through a set of standardized function calls. In one embodiment, the code objects are written in a suitable software language such as C++, but the code objects can be written in any low level or high level language. In one embodiment, the code modules are implemented in C++ and compiled on a computer running a content server, such as, for example, Microsoft® IIS or Linux® Apache. Alternatively, the code modules can be compiled with their own front end on a kiosk, or can be compiled on a cluster of server machines serving interactive television content through a cable, packet, telephone, satellite, or other telecommunications network. Artisans of skill in the art will recognize that any number of implementations, including code implementations directly to hardware, are also possible.

The website operator may operatively associate the interface module 120 with a number of different modules. For example, the interface module 120 may be operatively associated with registration module 130 to register users to the service provider website 116 and/or account manager module 126 to provide access to online banking deposit service. The website operator may implement the interface module 120 to receive data associated with a user account from user terminal 110. For example, the interface module 120 may receive an identifier, such as an e-mail address or an account log-in information, to verify the user's membership with the service provider website 116. The account log-in information may include an account username and password, for logging onto the service provider website 116 and for accessing associated user account.

The processing module 122 may be responsive to the receipt of an electronic image of the value-bearing instrument, receipt of a first data associated with the value-bearing instrument, and receipt of a second data associated with a user account from user terminal 110. The first data may include, for example, a name, an amount and a date on the value-bearing instrument. The second data may include, for example, an e-mail address or an account log-in information. A user may scan in the electronic image of the value-bearing instrument at the user terminal 110 and transmit it to the server 118. Alternatively, the user may send by facsimile the value-bearing instrument to the service provider, which can then be converted to an electronic image and forwarded to the processing module 122.

The processing module 122 may retrieve from the storage medium 128 the user's financial account information with a financial institution in response to the user account information received. The user's financial account information may include a routing number and an account number with a financial institution. The processing module 122 may then transmit the electronic image or a replica thereof, via for example the interface module 120, to the financial institution terminal 112 for processing. The replica of the electronic image of the value-bearing instrument may be a facsimile copy or an electronic copy sent, for example, by e-mail to the financial institution.

In one embodiment, the processing module 122 may identify a routing number and an account number on the value-bearing instrument in response to the receipt of an electronic image of the value-bearing instrument. The processing module 122 may scan through the electronic image of the value-bearing instrument at a predetermined location, such as the bottom region of the electronic image of the value-bearing instrument, to locate and identify printed routing number, account number information, bar codes, and the like.

As can be appreciated, the processing module 122 may also determine if the value-bearing instrument was previously submitted to the service provider website 116 for processing. For example, the information collected from the value-bearing instrument, such as routing number, account number, name, amount and date, are compared with previous submittals stored in storage medium 128. The processing module 122 may also encrypt the electronic image of the value-bearing instrument such that any transmission of the electronic image over the network 114 is secure.

The account manager module 126 may handle user accounts associated with service provider website 116. The website operator may operatively associate the account manager module 126 with interface module 120 to provide access to online banking deposit service. In one embodiment, the account manager module 126 may receive, via for example the interface module 120, an identifier, such as an e-mail address or an account log-in information, to verify the user's membership with the service provider website 116. In one embodiment, the user terminal 110 is associated with the user account. For example, the user terminal 110 may use a phone line to submit the electronic image of the value-bearing instrument. The phone line has a phone number at a known location; and the user of the account with the web site is the same user of the phone number. Thus, when the user terminal 110 transmits the electronic image of the value-bearing instrument to the service provider website 116 using the phone line (e.g., via a fax gateway, or an Internet connection over the phone line), the service provider website 116 can identify the user account based on the phone line and/or authenticate the user based at least in part on the identity of the phone line (e.g., the phone number). In some embodiments, the service provider provides both the telecommunications services for the phone line and the deposit services and uses account information for the phone line in the authentication of the user in the deposit service, and/or in the identification of the user's financial account information with the financial institution, into which the user deposits the value-bearing instrument. In other embodiments, the user terminal 110 may submit the electronic image of the value-bearing instrument via communications connection provided via cable television services, or via cellular communications services. The service provider website 116 may identify the user via the cable account or the cellular phone account.

The registration module 130 may facilitate registration with the service provider website 116. The registration module 130 may be responsive to a user's request to register on the service provider website 116. The registration module 130 may allow a user to set up account log-in information such as an account username and password to log onto the service provider website 116. The account log-in information may be stored in storage medium 128 and retrieved by account manager module 126 to verify the user's membership with the service provider website 116.

As is understood by a person skilled in the art, the website operator may compile the code modules on one or more servers 118, each having one or more processors, to perform a set of functional calls. In one embodiment, the one or more processors may be configured, programmed and/or provided code instructions from one or more modules to receive an individual's sign up information from user terminal 110, verify the individual's membership for accessing the service provider website 116, receive an electronic image of the value-bearing instrument from the user terminal 110, retrieve from the storage medium 128 the user's financial account information, and transmit the electronic image or a replica thereof to the financial institution for processing.

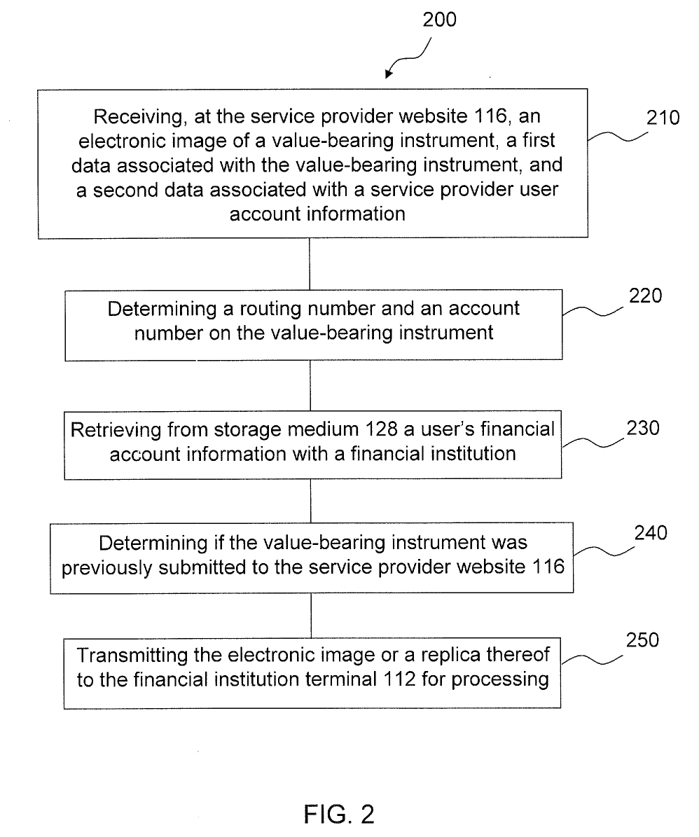

FIG. 2 illustrates an exemplary flowchart 200 outlining the operation of the system 100 for depositing a value-bearing instrument in a financial account, according to an embodiment of the present disclosure. The method begins by receiving, at the service provider website 116, an electronic image of the value-bearing instrument, a first data associated with the value-bearing instrument, and a second data associated with a service provider user account information (210). The electronic image of the value-bearing instrument may be an image scanned by a scanner (not shown) coupled to the user terminal 110. Alternatively, the electronic image may be a facsimile transmitted to the website 116 by a user at user terminal 110. The first data may include a name, an amount and a date on the value-bearing instrument. The second data may include an e-mail address and/or an account log-in information. Next, the service provider website 116 determines a routing number and an account number on the value-bearing instrument (220). The processing module 122 of the service provider website 116 may scan through the electronic image of the value-bearing instrument at a predetermined location, such as the bottom region of the electronic image of the value-bearing instrument, to locate and identify printed routing number, account number, bar codes and the like.

Next, the service provider website 116 retrieves from storage medium 128 a user's financial account information with a financial institution (230). The user's financial account information may include a routing number and an account number with the financial institution. Alternatively, the service provider website 116 may receive the user's financial account information with the first data and/or the second data. In one embodiment, the website operator may configure the service provider website 116 to determine if the value-bearing instrument was previously submitted to the service provider website 116 (240). Finally, the service provider website 116 transmits the electronic image or a replica thereof to the financial institution terminal 112 for processing (250). The replica of the electronic image of the value-bearing instrument may be a facsimile copy or an electronic copy sent, for example, by e-mail to the financial institution.

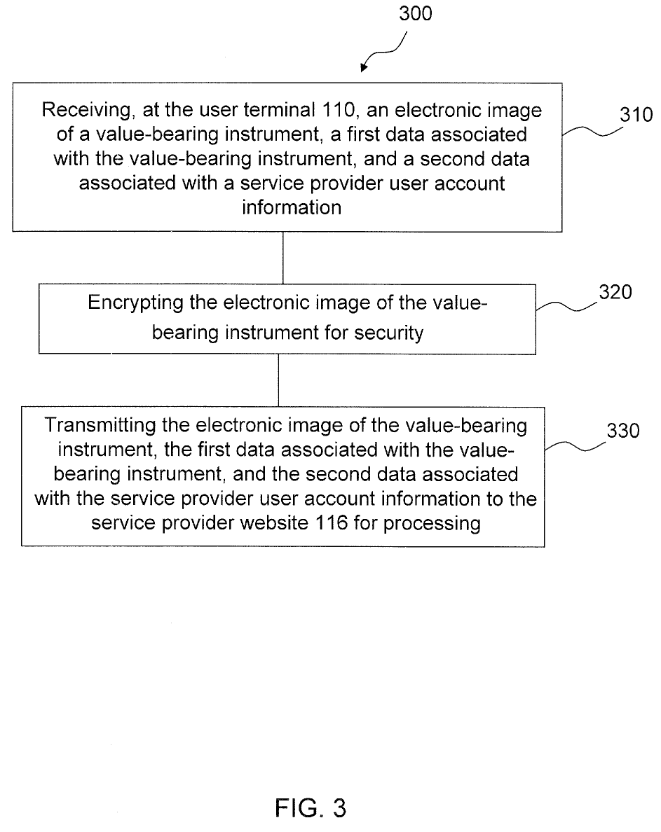

FIG. 3 illustrates an exemplary flowchart 300 outlining the operation of the user terminal 110 executing instructions for depositing a value-bearing instrument in a financial account, according to an embodiment of the present disclosure. The executable instructions may allow the user terminal 110 to receive an electronic image of a value-bearing instrument, a first data associated with the value-bearing instrument, and a second data associated with a service provider user account information (310). The electronic image of the value-bearing instrument may be received by scanning the value-bearing instrument with a scanner (not shown). The first data associated with the value-bearing instrument, such as the name, the amount and the date on the value-bearing instrument may be manually inputted by a user. Additionally, the second data associated with a service provider user account information, such as an e-mail address and/or an account log-in information, may be manually inputted by a user or automatically generated at the user terminal 110.

Next, the executable instructions may trigger the user terminal 110 to encrypt the electronic image of the value-bearing instrument for security (320). Then, the executable instructions may cause the user terminal 110 to transmit the electronic image of the value-bearing instrument, the first data associated with the value-bearing instrument, and the second data associated with the service provider user account information, to the service provider website 116 for processing (330).

As can be appreciated, the online banking deposit service may allow financial institutions to collect deposits electronically from remote locations, such as homes and businesses. A user of the service provider website 116 may collect received checks, endorse them as normal, then scan both sides of each check to upload to the user terminal 110. The user may then transmit them to the service provider website 116. Alternatively, the user may send a facsimile to the service provider, which can convert the facsimile to an electronic image. As the value-bearing instrument have the necessary electronic barcodes, routing codes, and account codes already on them, all necessary information to confirm the checking deposit is available to transfer to the user's financial institution. In one embodiment, upon receipt of the electronic image of the value-bearing instrument, the service provider may prompt the user to enter their banking routing number and account number to which they want the deposit credited. Alternatively, such information may be retrieved from storage medium 128. In one embodiment, the service provider website 116 may then transmit an acknowledgment receipt of the deposit request, charges the user account a service fee, and transfers the data to the financial institution hosting the user's account. The financial institution may then verify the value-bearing instrument being deposited. In one embodiment, the service provider website 116 may display various deposit transactions and statuses.

The online banking deposit service allows users to deposit their value-bearing instruments online. As such, financial institutions may reduce in-person transactions and associated personnel costs. Financial institutions may receive timely deposits and allow their customers to perform electronic transactions that further reduce their personnel costs. Additionally, the online banking deposit service may enable financial institutions with the means to securely identify the customer performing the transaction. The service provider website 116 verification and security means provides an additional layer of security to financial institutions to prevent forgeries. Since financial institutions have no physical presence at a user terminal 110, they do not have a means to add this additional layer of location based security on their own using their own electronic service without the features embodied in the present invention.

While the method and system have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Such terms should be interpreted in their most expansive forms so as to afford the applicant the broadest coverage legally permissible.

1. A method of depositing a value-bearing instrument in a financial account, the method comprising:
receiving an electronic image of the value-bearing instrument at a processor of a service provider;
retrieving from a storage medium a user's financial account information with a financial institution to deposit the value-bearing instrument; and
transmitting a replica of the electronic image of the value-bearing instrument to the financial institution to deposit the value-bearing instrument into an account identified by the user's financial account information with the financial institution.

2. The method of claim 1, further comprising receiving data associated with a user account from a user terminal prior to receiving an electronic image of the value-bearing instrument at a processor of a service provider, the data is selected from a group consisting of an e-mail address and an account log-in information.

3. The method of claim 1, further comprising encrypting the electronic image of the value-bearing instrument for security prior to receiving an electronic image of the value-bearing instrument at a processor of a service provider.

4. The method of claim 1, wherein the user's financial account information is selected from a group consisting of a routing number and an account number with the financial institution.

5. The method of claim 1, wherein the electronic image is scanned at a user terminal.

6. The method of claim 1, wherein transmitting a replica of the electronic image of the value-bearing instrument comprises transmitting a facsimile copy of the electronic image.

7. The method of claim 1, wherein transmitting a replica of the electronic image of the value-bearing instrument comprises transmitting a copy of the electronic image by e-mail.

8. The method of claim 1, further comprising receiving data associated with the value-bearing instrument from a user terminal, the data is selected from a group consisting of a name, an amount and a date on the value-bearing instrument.

9. The method of claim 1, further comprising identifying a routing number and an account number on the value-bearing instrument after receiving an electronic image of the value-bearing instrument at a processor of a service provider.

10. The method of claim 1, further comprising determining if the value-bearing instrument was previously submitted to the processor prior to transmitting a replica of the electronic image of the value-bearing instrument to the financial institution for processing.

11. A system for depositing a value-bearing instrument in a financial account, comprising:
a storage medium for storing a user's financial account information with a financial institution; and
a processor configured to:
receive an electronic image of the value-bearing instrument,
retrieve from the storage medium the user's financial account information, and
transmit a replica of the electronic image of the value-bearing instrument to the financial institution to deposit the value-bearing instrument into an account identified by the user's financial account information with the financial institution.

12. The system of claim 11, wherein the processor is further configured to encrypt the electronic image of the value-bearing instrument.

13. The system of claim 11, wherein the processor is further configured to receive, from a user terminal, a first data associated with the value-bearing instrument and a second data associated with a user account, the first data is selected from a group consisting of a name, an amount and a date on the value-bearing instrument, the second data is selected from a group consisting of an e-mail address and an account log-in information.

14. The system of claim 11, wherein the user's financial account information is selected from a group consisting of a routing number and an account number with the financial institution.

15. The system of claim 11, wherein the processor is further configured to determine a routing number and an account number on the value-bearing instrument.

16. The system of claim 11, wherein the processor is further configured to determine if the value-bearing instrument was previously submitted for processing.

17. A computer readable medium having stored thereon a set of instructions, which when executed by a computer having a processor and a memory, cause the computer to perform operations, comprising:
receiving a scanned image of a value-bearing instrument;
retrieving a user's financial account information with a financial institution to deposit the value-bearing instrument; and
transmitting a replica of the scanned image to the financial institution to deposit the value-bearing instrument into an account identified by the user's financial account information with the financial institution.

18. The computer readable medium of claim 17, further comprising receiving, from a user terminal, a first data associated with the value-bearing instrument and a second data associated with a user account, the first data is selected from a group consisting of a name, an amount and a date on the value-bearing instrument, the second data is selected from a group consisting of an e-mail address and an account log-in information.

19. The computer readable medium of claim 17, wherein transmitting a replica of the scanned image comprises transmitting a facsimile copy of the scanned image.

20. A computer readable medium having stored thereon a set of instructions, which when executed by a computer having a processor and a memory, cause the computer to perform operations, comprising:
receiving a scanned image of a value-bearing instrument, a first data associated with the value-bearing instrument, and a second data associated with a service provider user account information, the first data comprising a name, an amount and a date on the value-bearing instrument, the second data comprising an account log-in information; and
transmitting the scanned image of the value-bearing instrument, the first data associated with the value-bearing instrument, and the second data associated with the service provider user account information to a processor of a service provider for processing,
wherein the processing comprises depositing the value-bearing instrument in a user's financial account at a financial institution.
